(19) United States
(12) Patent Application Publication
(10) Pub. No.: US 2026/0031092 A1
(43) Pub. Date: Jan. 29, 2026

(54) TRAINING AUDIO ENCODER NEURAL NETWORKS USING DENOISING LOSSES

(71) Applicant: GDM Holding LLC, Mountain View, CA (US)

(72) Inventors: Yuan Gao, Sunnyvale, CA (US); Nanxin Chen, Jersey City, NJ (US)

(21) Appl. No.: 19/284,539

(22) Filed: Jul. 29, 2025

Related U.S. Application Data
(60) Provisional application No. 63/676,870, filed on Jul. 29, 2024.

(51) Int. Cl. G10L 19/00; G10L 19/02

(52) U.S. Cl. CPC G10L 19/0017; G10L 19/02

(57) ABSTRACT

Methods, systems, and apparatuses, including computer programs encoded on computer storage media, for training an audio encoder neural network. In particular, the described techniques include generating a noisy segment and an encoded representation from a particular segment using the audio encoder and processing both using a decoder neural network to generate a reconstruction of the particular segment. Then, training the audio encoder on a loss function that measures a reconstruction error between the particular segment and the reconstruction. Because training on the reconstruction loss results in encoded representations that contain sufficient information to reconstruct the particular segment, the resulting audio encoder can generate encoded representations that contain enough information to generalize well for various different downstream tasks.

### CLAIM OF PRIORITY

This application claims priority to U.S. Provisional Application Ser. No. 63/676,870, filed on Jul. 29, 2024, the entire contents of which are hereby incorporated by reference.

### BACKGROUND

This specification relates to processing audio inputs using neural networks.

Neural networks are machine learning models that employ one or more layers of nonlinear units to predict an output for a received input. Some neural networks include one or more hidden layers in addition to an output layer. The output of each hidden layer is used as input to the next layer in the network, i.e., the next hidden layer or the output layer. Each layer of the network generates an output from a received input in accordance with current value inputs of a respective set of parameters.

### SUMMARY

This specification describes a system implemented as computer programs on one or more computers in one or more locations that trains an audio encoder neural network.

Particular embodiments of the subject matter described in this specification can be implemented so as to realize one or more of the following advantages.

To perform machine learning tasks on audio signals (e.g., automatic speech recognition, speech translation, audio question-answering, and so on), audio encoder neural networks that can robustly represent relevant characteristics of an audio signal are critical. For example, the better the encoded representations of segments that make up a spectrogram representing an audio signal, the better the performance of downstream machine learning tasks that utilize these encoded representations of segments will be.

However, due to the wide range of types of audio signal (i.e., wide range of sources of audio signals, categories of audio signal, e.g., speech, music, or ambient noise, signal-to-noise ratio of the audio signal, and so on) and limited labeled audio signals (e.g., transcribed speech audio), training an audio encoder neural network that can generate robust encoded representations of segments of a spectrogram is challenging.

To overcome the difficulties of variability of types of audio signals and of limited labeled audio signals, some techniques to train an audio encoder neural network rely on self-supervised training along with the use of contrastive loss functions. In other words, these techniques train an audio encoder to generate encoded representations of segments that can be used to distinguish similar and dissimilar segments and do not use explicit labels for the segments. In addition, some techniques that use contrastive loss functions are further improved with the use of quantization (i.e., a mapping of continuous encoded representations to a discrete encoded representation from a finite vocabulary). The use of quantization makes training with contrastive loss functions more tractable by restricting the encoded representations of segments to a finite set and enables the use of techniques for further training that require inputs from a finite set. For example, for the training of the vq-wave2vec audio encoder (as described in arXiv:1910.05453), continuous encoded representations of segments generated by an audio encoder are mapped to discrete encoded representations, and the audio encoder is trained on a context prediction task (i.e., a contrastive loss). Then the audio encoder is further trained using a BERT style technique where the task is to predict masked discrete encoded representations of segments based on the discrete encoded representations of the surrounding segments.

However, the reliance of some techniques on contrastive loss with quantization to train an audio encoder neural network creates an inherent limit on the use of the encoded representation of segments for downstream tasks. That is, quantization requires special designed initialization or additional tuning for the quantization codebook (i.e., the set of discrete encoded representations that continuous encoded representations are mapped onto) and inherently introduces bias from the design of the quantization algorithm. This inherited bias from the quantization design limits the encoded representations' expressiveness for different downstream tasks, with downstream tasks that align with quantization performing better than those tasks that do not.

This specification describes techniques that can address the aforementioned challenges. That is, this specification describes techniques that include training a decoder neural network and an audio encoder neural network on a loss function that measures a respective error between a particular segment and a reconstruction of the particular segment. In particular, the particular segment is one of many belonging to a spectrogram representing an audio signal, and the described techniques generate the reconstruction of the particular segment by processing a noisy particular segment and an encoded representation of the particular segment using the decoder neural network. Further, the described techniques use the audio encoder neural network to generate the encoded representation of the particular segment from a masked spectrogram (i.e., a masked version of the spectrogram, i.e., the spectrogram where one or more of the segments that includes the particular segment are masked). Because the loss function measures the error of a process that removes noise (i.e., generating the reconstruction of the particular segment by processing the noisy segment using the decoder neural network), the loss function can be referred to as a “denoising loss.” Alternatively, because the result of training the decoder neural network and the audio encoder neural network on the loss function is a decoder neural network that can generate a faithful reconstruction of the particular segment, the loss function can also be referred to as a “reconstruction loss”. While the loss function may be referred to by various terms, including, a “denoising loss” or a “reconstruction loss”, the loss function is one that measures a respective error between the particular segment and the reconstruction of the particular segment generated from the noisy segment. Hereinafter, the loss function can be referred to as “denoising loss” or as “reconstruction loss,” which can be considered a form of denoising loss.

In other words, the described techniques, do not rely on contrastive loss or quantization to train the audio encoder neural network but instead rely on a reconstruction loss. As a result of training the audio encoder neural network using a reconstruction loss, the resulting encoded representations of audio segments generated using the trained audio encoder are no longer biased (as is the case when training the audio encoder neural network included the use of quantization) and are more general, informative representations because they are not restricted to being a part of the pre-defined codebook, making them compatible for a variety of downstream tasks. Consequently, the performance of the downstream tasks (e.g., any of the tasks described above or below) is improved when using an audio encoder neural network trained using the described techniques.

In addition, by avoiding quantization (i.e., the mapping of encoded representations of segments from a continuous representation to a discrete representation of a codebook), the described techniques improve the computational efficiency of training the encoder by eliminating the need for and development of a codebook entirely.

Beyond the improved computational efficiency and generalizability of the encoded representations for downstream tasks due to the avoidance of the use of a contrastive loss function and a codebook, the described techniques' use of a reconstruction loss causes the audio encoder to learn encoded representations that contain more information than would be the case if contrastive loss were used. That is, because the described techniques generate the reconstruction of the particular segment by processing an encoded representation of the particular segment using the decoder neural network and trains the audio encoder on a reconstruction loss, the resulting audio encoder generates encoded representations for the segments that are informative enough to generate an accurate reconstruction of the segments, which means that the encoded representations contain rich information of the respective segment. Whereas the use of a contrastive loss for training the audio encoder causes the audio encoder to generate encoded representations that are good for classification (i.e., determining if encoded representations are similar or dissimilar) but will not contain as much information as the encoded representations generated by the described techniques.

Also, the described techniques' inclusion of processing a masked spectrogram to generate the encoded representation of the particular segment during training cause the audio encoder to learn encoded representations that take into account the surrounding segments. That is, by masking segments of the spectrogram and generating encoded representations from the masked spectrogram during training, the described techniques cause the audio encoder to learn encoded representations that utilize and include contextual information.

Ultimately, the described techniques' combined use of the above described reconstruction loss and processing of masked spectrograms result in an audio encoder that produces an encoded representation for each segment of a spectrogram that is highly informative of the segment itself and of the surrounding contextual segments.

The details of one or more embodiments of the subject matter of this specification are set forth in the accompanying drawings and the description below.

Other features, aspects, and advantages of the subject matter will become apparent from the description, the drawings, and the claims.

### BRIEF DESCRIPTION OF THE DRAWINGS

FIG. 1 shows an audio encoder training system.

FIG. 2 is a flow diagram of an example process for training an audio encoder neural network.

FIG. 3 is a flow diagram of an example process for updating trainable parameters during training of the decoder neural network and the audio encoder neural network.

FIG. 4 is a flow diagram of an example process for fine-tuning an audio encoder neural network on a downstream task.

FIG. 5 is an example of the performance of the described techniques.

FIG. 6 is an example of the performance of the described techniques.

FIG. 7 is an example of the performance of the described techniques.

Like reference numbers and designations in the various drawings indicate like elements.

### DETAILED DESCRIPTION

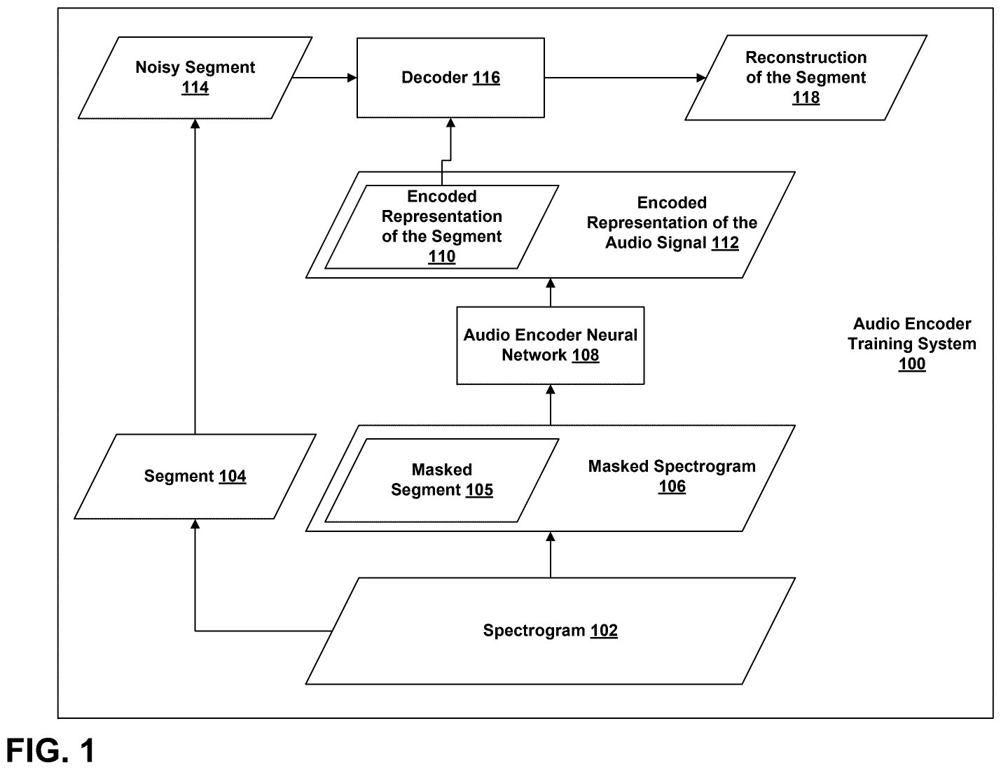

FIG. 1 shows an example audio encoder training system 100. The system 100 is an example of a system implemented as computer programs on one or more computers in one or more locations, in which the systems, components, and techniques described below can be implemented.

The audio encoder training system 100 trains an audio encoder neural network 108. The audio encoder neural network 108 is a neural network that is configured to process a spectrogram 102 representing an audio signal to generate an encoded representation of the audio signal 112. After the system 100 trains the audio encoder neural network 108, the system 100 can use the audio encoder neural network 108 to process new spectrograms to generate new encoded representations and use the new encoded representations for downstream tasks.

The encoded representation of the audio signal 112 generally includes a respective encoded representation of each of multiple segments of the audio signal, where each segment corresponds to a different time window within the audio signal. The encoded representation of a given segment is an ordered collection of numerical values, e.g., a vector of numerical values, a matrix of numerical values, or a higher-order tensor of numerical values.

The audio encoder neural network 108 can have any appropriate architecture that maps a spectrogram 102 to an encoded representation 112. For example, the audio encoder neural network 108 can have a sequence processing neural network architecture.

As one example, the audio encoder neural network 108 can be a convolutional neural network.

As another example, the audio encoder neural network 108 can be a self-attention neural network, i.e., a neural network that includes one or more self-attention layers.

As yet another example, the audio encoder neural network 108 can include both convolutional layers and self-attention layers. As one particular example of this, the audio encoder neural network 108 can have a Conformer (“Convolution-augmented Transformer”) neural network architecture.

After the system 100 trains the audio encoder neural network 108, the system 100 or another inference system can use the audio encoder neural network 108 to perform a downstream task.

For example, after training, the system 100 can receive a new input that includes a spectrogram representing a new audio signal.

The system 100 processes the new input to generate an encoded representation of the new input, including processing the spectrogram using the (trained) audio encoder neural network 108 to generate an encoded representation of the new audio signal.

The system 100 then processes the encoded representation of the new input using a downstream neural network to perform a downstream task on the new input.

As a particular example, the downstream neural network can be a multi-modal generative neural network. Examples of multi-modal generative neural networks are provided below.

The downstream task can generally be any appropriate task that requires processing an input that includes audio.

For example, the task can be automatic speech recognition. In this task, the system can receive an audio signal as input and generate text as an output. The audio signal can be a speech signal and the text can include a transcript of the content of the speech signal. In some of these examples, the input can also include data of another modality that provides context for the audio signal, e.g., image or video data.

As another example, the task can be automatic speech translation. In this task, the system can receive an audio signal as input and generate text as an output. The audio signal can be a speech signal and the text can include a translated transcript of the content of the speech signal in a different language than was included in the speech signal.

As another example, the task can be speech to speech translation. In this task, the system can receive an audio signal as input and generate an audio signal as an output. The input audio signal can be a speech signal and the output audio signal can include the same semantic content as the speech signal but spoken differently. For example, the input audio signal can include speech in one natural language and the output audio signal can represent speech in a target, different natural language that is a translation of the input speech into the target language.

As another example, the task can be audio question answering. In this task, the system can receive an input that include audio and a query about the audio, e.g., represented as audio or as text, and the system can generate as output a response to the query, e.g., represented as audio or as text.

As another example, the task can be a task to respond to a query about a different modality of data, e.g., text, image, or video data. In this task, the system can receive an input that includes data of a non-audio modality and an audio query about the data of the non-audio modality and the system can generate as output a response to the audio query, e.g., represented as audio or as text.

As another example, the system can perform transcript conditioned speech enhancement, where the input is a text transcript and noisy audio corresponding to the text transcript and the output audio signal is clean audio corresponding to the text transcript.

As another example, the system can perform transcript-based audio in-filling, where the input is a text transcript and audio corresponding to a portion of the text transcript, and the output audio signal corresponds to a different portion of the text transcript.

As another example, the system can perform speaker-conditioned text-to-speech, where the input is a text transcript and audio of a speaker and the output audio signal is a verbalization of the text transcript being spoken by the speaker.

As another example, the system can perform audio-video continuation, where the system receives a partial audio track with corresponding video, and the output audio signal is a continuation of the partial audio track.

As another example, the system can perform cross-modal in-filling, where the system receives video and an audio track corresponding to a portion of the video and the output audio signal is an audio track corresponding to a different portion of the video.

As another example, the system can perform audio language modeling, where the system receives an input that includes an audio signal and the output is an audio signal that is a predicted continuation of the audio signal.

As another example, the system can perform audio-conditioned data item generation, where the input is audio and the output is a data item, e.g., text, image, or video, that is described by the input audio.

In some implementations, the task can require performing a combination of tasks. For example, a task can include multiple subtasks and the system can perform the combination of subtasks. As an example, the system perform speech to speech translation to directly output an audio signal in French from an input audio signal in English. Alternatively, the system can output English text, followed by French text, followed by an audio signal in French.

As part of training the audio encoder neural network 108, the system 100 can obtain a spectrogram representing an audio signal 102. As described above, the spectrogram 102 includes a plurality of segments, with each corresponding to a different time window within the audio signal.

The system 100 generates, from the spectrogram 102, a masked spectrogram 106. As part of generating the masked spectrogram 106, the system 100 generates a masked segment 105 corresponding to a particular segment 104 of the plurality of segments. That is, the masked spectrogram 106 includes (i) the masked segment 105 corresponding to the particular segment 104 and (ii) unmasked segments corresponding to other segments of the plurality of segments, i.e., unmasked segments that have not been masked by the system 100 and include the original content of the corresponding spectrogram 102.

In some cases, the system 100 generates a masked spectrogram 106 that includes more than one masked segment. That is, to generate the masked spectrogram 106, the system 100 can select one or more segments of the spectrogram 106 to mask that include the particular segment 104. For example, to select one or more segments of the spectrogram 106 to mask, the system 100 can determine with a specified probability at every segment whether to apply a mask to a span (i.e., a fixed number of two or more sequential segments) that begins at the segment, where at least one of the masked spans includes the particular segment 104.

The system 100 processes the masked spectrogram 106 using the audio encoder neural network 108 to generate an encoded representation of the audio signal 112 that includes a respective encoded representation of the particular segment 110.

The system 100 generates, from the particular segment 104, a noisy segment 114. For example, the system 100 can sample noise from a particular distribution, e.g., multivariate Gaussian distribution, and combine it with the particular segment 104 to generate the noisy segment 114 (i.e., an elementwise sum across the dimensions of the sampled noise and the values of the particular segment). As another example, the system 100 can sample a noise time step to determine a noise level and combine sampled noise from a specified distribution with the particular segment 104 to generate the noisy segment 114 in accordance with the noise level. Further details of generating a noisy segment 114 are described below.

The system 100 processes the respective encoded representation of the particular segment 110 and the noisy segment 114 using a decoder neural network 116 to generate a reconstruction of the particular segment 118. The decoder neural network 116 can have any appropriate architecture that processes at least the encoded representation of the particular segment 110 and the noisy segment 114 to generate the reconstruction of the particular segment 118.

As one example, the decoder neural network 116 can be a convolutional neural network (e.g., a convolutional neural network that includes cross-attention layers and processes a primary input and a separate input as a conditional input through the cross-attention layers). For example, the decoder neural network 116 can be a conditional U-net based neural network with conditional layer(s), where the primary input to the U-net based neural network includes the noisy segment 114 and the separate input to the U-net based neural network can include the encoded representation of the particular segment 110.

The system 100 trains the decoder neural network 116 and the audio encoder neural network 108 on a loss function that measures a respective error between the particular segment 104 and the reconstruction of the particular segment 118 generated from the noisy segment 114.

While the above description indicates that the system 100 generates a noisy segment 114 from the particular segment 104, the system 100 can generate multiple noisy segments from the particular segment 104, i.e., can generate one or more additional noisy segments in addition to the noisy segment 114 described above. In these cases, the loss function measures, for each noisy segment generated from the particular segment 104, a respective error between the particular segment 104 and the respective reconstruction of the particular segment generated from the noisy segment.

Similarly, when the system 100 selects one or more segments to mask that include the particular segment 104, the system 100 can also generate one or more respective noisy segments for each selected segment. In these cases, the loss function measures, for each noisy segment generated from each selected segment, a respective error between the selected segment and the respective reconstruction of the selected segment generated from the noisy segment.

As described above, in some implementations the downstream neural network can be a generative neural network.

For example, the generative neural network can be a multimodal network that is configured to process a conditioning input comprising one or more of text data, audio data defining an audio signal (e.g., as amplitude values of the audio signal or as a time-frequency representation of the audio signal), or a still or moving image (e.g., as image pixel values), to generate a data item that can similarly comprise text data, audio data, or a still or moving image.

For example, the conditioning input may comprise text and the data item may comprise an image or an audio signal that represents speech an image generated in response to the text, e.g., described by the text. Also, or instead, the conditioning input may comprise an audio signal that represents speech, or an image, and the data item may comprise text, e.g., that describes the conditioning input.

As another example, the conditioning input may comprise an observation, e.g., of a real world environment, e.g., from sensor such as a camera or other image sensor; and optionally additional information such as information defining a particular task to be deformed. The output data item may comprise agent control data that defines one or more actions to be performed by an agent, e.g., by a mechanical agent such as a robot or autonomous vehicle, to perform a task. The reward model(s) may, e.g., define a preferred trajectory of motion of the mechanical agent in the (real-world) environment.

In some implementations the generative neural network may comprise a language and/or image generation neural network, that may have been trained before being fine-tuned (as will be described below). The conditioning input may comprise a prompt, e.g., a natural or computer language prompt for the generative neural network. The generated data item may comprise a natural or computer language and/or image response to the prompt.

In general, the generative neural network can have any appropriate architecture for processing the conditioning input to generate the data item.

As one example, the generative neural network may comprise an auto-regressive generative model (e.g., a Transformer, a recurrent neural network, etc.) that can auto-regressively generate an output sequence as the data item based on the conditioning input. The generative model can, for example, comprise a large language model (LLM) that can auto-regressively generate tokenized representations of text data, a vision-language model (VLM) that can auto-regressively generate tokenized representations of image or video data, e.g., in response to a text conditioning input or that can auto-regressively generate tokenized representations of text, e.g., in response to an image conditioning input, an audio language model that can auto-regressively generate tokenized representations of text data, or a multimodal model that can that can generate tokens representing any of text, image or audio, e.g., in response to a conditioning input comprising any of text, image or audio, and so forth.

As another example, the generative neural network may comprise a diffusion model (e.g., a denoising diffusion model, a score-based diffusion model, a latent diffusion model, etc.) that can generate the data item by repeatedly transforming samples from a noise distribution (e.g., a Gaussian distribution) based on the conditioning input over a sequence of iterations. For example, the generative neural network may comprise a diffusion model that transforms samples from the noise distribution using a denoising neural network with any appropriate architecture (e.g., a convolutional neural network, a recurrent neural network, etc.). Such a diffusion model may be used to generate, e.g., a still or moving (video) image.

As another example, the generative neural network may comprise a neural network that can generate the data item by transforming samples from a noise distribution (e.g., a Gaussian distribution). The generative neural network may comprise, e.g., a generator network of a generative adversarial network, a decoder of a variational auto-encoder, a normalizing flow, and so on.

As used herein an image may be any still or moving image, i.e., the image may be part of a video, in 2D or 3D, and may be a monochrome, color or hyperspectral image, i.e., comprising monochrome or color pixels. As defined herein an “image” includes a point cloud, e.g., from a LIDAR system, and a “pixel” includes a point of the point cloud. An image may have been captured by a camera or other image sensor from the real world; and objects in the image may comprise physical objects, represented by the image.

In some implementations the generative neural network, e.g., a language model or a visual language model, is stored on a user computing device, i.e., a device local to the user, such as a mobile device, e.g., a mobile phone, or a smart speaker.

In some implementations the generative neural network is implemented on a remote server in communication with a user computing device over a wired or wireless network communications link between the user computing device and the server.

The user computing device may be provided with an input mechanism, such as a text or voice interface, that enables user input from the user in a natural language. The user computing device may be provided with an output mechanism that provides a system output for the user in the or another natural language, e.g., as speech or text; or in some other way, e.g., by displaying an image. The input and output mechanism may comprise, e.g., a keyboard, microphone, speaker, display, and/or camera.

As an example, the input mechanism may comprise a system configured to input audio data characterizing a speech waveform of speech representing the input from the user in a natural language, and configured to convert the audio data into tokens representing the speech in the natural language, e.g., representing a transcription of the spoken input. The output mechanism may comprise a system configured to receive tokens representing the output for the user in the or another natural language and a system configured to convert the received tokens into audio data representing a waveform of speech representing the output to the user in the natural language, i.e., representing spoken words.

As a further example, the system 100 can be deployed in an environment that enables a user to provide a request for the system 100, e.g., to process a multimodal conditioning input to generate a corresponding data item output. A user can provide the request, e.g., by way of a user interface or through an application programming interface (API). The request can be transmitted from a user device, e.g., over a data communications network such as the internet, to one or more computers implementing the system 100, e.g., in a data center. The system 100 can generate a data item and then transmit the data item to a user device over a data communications network.

The (trained) generative neural network can be used for diagnosing a fault, or for correcting undesired behavior, in a mechanical or computing system operating in the real world environment. The conditioning input may comprise a description and/or image of one or more observations of the mechanical or computing system, e.g., of operation of the system, optionally obtained from one or more sensors sensing a condition or operation of the system. An image observation may be converted into a text description, e.g., using an image captioning system or in other ways. The generated data item may comprise an image, audio, or text that identifies (described) a likely cause of the fault or undesired behavior. This may be used to repair the fault or correct the behavior. The reward model can define relatively more useful types of output for repairing the fault or correcting the behavior.

The (trained) generative neural network can be used for controlling a mechanical agent such as a robot or vehicle. For example the conditioning input may comprise a description of a task to be performed, and the generated data item may comprise a list of sub-tasks to be performed by the mechanical agent (trained to perform such sub-tasks), in order to perform the task. The reward model can define relatively more preferable or useful types of sub-task.

The generative neural network may comprise a multimodal machine learning system such as a visual language model (VLM). That is implementations of the generative neural network can perform a multimodal task in which the conditioning input and data item, collectively, comprise data of multiple different types. As used herein text can include numbers, punctuation, special symbols, and so forth.

In some implementations, after training, a particular task that is to be performed by the generative neural network can be described by part or all of a sequence of text in the conditioning input to the system 100. For example in a conditioning input that includes an image such a prompt might specify “Generate a caption”, “Generate a description”, “Answer the following question: [about the image or video]”, or “Detect a person”. Where the system 100 is used for an agent control task a prompt may define “Take the knife out of the drawer”, or “Q: What action should the robot take to take the knife out of the drawer?”. Also or instead such a prompt may give one or more examples of a task to be performed. The generative neural network can be trained on multiple natural and/or computer languages and the prompt may then specify a language to use.

A few further examples of some machine learning tasks that can be performed by a system 100 as described herein follow. The tasks described below may be tasks that require spatial awareness or other context from the image or video. For example, a prompt may ask “What is the object in the top left corner?”.

In general for the tasks below the components of the system 100 can have been trained or fine-tuned on examples of the input and output for the task. For example, the components of the system 100 can have been trained using still or moving images containing one or more objects or actions, and corresponding sequences of text or other data, e.g., describing or classifying the images. However large, “foundation” models can, in general, perform some tasks zero-shot, i.e., without having been specifically trained on those tasks.

As one example the task may comprise an object or action detection task. For example, the generated data item may comprise or represent text that describes or otherwise labels detected object(s) or action(s) in a conditioning input comprising an image or audio, and may include coordinates such as bounding-box coordinates for the detected object(s) or action(s), e.g., “10 20 90 100 cat 20 30 100 100 dog”.

As another example the task may comprise a classification task, e.g., an object or action classification task. The generated data item may comprise data, e.g., text, that classifies the object(s) or action(s) in represented in the conditioning data, e.g., in an image or audio, into one of a plurality of classes, or that otherwise classify object(s) or action(s) represented in the conditioning data.

As another example the task may comprise a still or moving image describing task, e.g., a captioning task (which, as used here, includes an audio description task to explain what is happening in an image). The generated data item may comprise data, e.g., text, describing an image or video in the conditioning data. For example, the generated data item may provide a caption or description or it may count objects in the image or video, or it may provide some other form of description.

As another example the task may comprise a still or moving image question-answering task. The generated data item may comprise data, e.g., text, that answers a question about the conditioning input, e.g., an image or audio, where the question is also specified in the conditioning input, e.g., as sequence of text. This may be used, e.g., to answer questions about visual plots and charts or about sounds.

As another example the task may comprise a character or word recognition task, e.g., an OCR (optical character recognition) task. The conditioning input may comprise a still or moving image and the generated data item may comprise text that represents characters or words in the conditioning input, e.g., in a natural language.

As another example the task may comprise a still or moving image generation task. The generated data item may comprise image data defining values for pixels of a still or moving image, and the conditioning input, e.g., a sequence of text, may describe or characterize the image to be generated. Merely as an example, an image of a plot or chart may be generated to represent the conditioning input, e.g., comprising text.

As another example the task may comprise a computer language text generation task. The conditioning data may comprise a natural language description of a task to be performed, and optionally an image (if the task is to be performed on or in relation to an image), and the generated data item may comprise text in a computer language to perform the task, e.g., a task of analyzing the content of the image to provide a result of the analysis or to search for information relating to the content of the image.

As a particular example the computer language in the generated data item may comprise computer language for invoking a function or calling one or more external APIs. Merely as one example, such a data item may comprise data formatted as a JSON object. As previously, the conditioning input may define the task to be performed and may also include an image in relation to which the task is to be performed. In general the task can involves manipulation of particular types of data that may benefit from access to an API such as mathematical data, date/time related data, scientific data, recent data that may post-date training of the system (that may be accessed by a search function or API), and so forth; and the generated data item may comprise text in a computer language for performing the task. The method may then include using the text in the computer language to perform the task.

In general where the generated data item comprises text this may be converted to speech representing the text, and an audio (speech) output provided.

In some implementations the task comprises an agent control task in which the agent interacts with an environment to perform the agent control task. In these implementations the conditioning input can include an observation characterizing the environment. For example the conditioning input can include a sequence of text that defines the task to be performed by the agent and the image can represent an observation of the environment, e.g., captured by a camera or other imaging device from a real-world environment. The generated data item can comprise an action selection output, e.g., including text, that is used to select one or more actions to be performed by the agent in the environment in response to the observation. As an illustration the generated data item may define an action as text such as “A: 132 114 128 5 25 156”, that can be converted into a control signal for a mechanical agent, such as a robot, e.g., “ΔT=[0.1,−0.2,0] ΔR=[10°,25°,−7°]”. The action selection output may also or instead define one or more low-level skills, e.g., from a vocabulary of previously learnt skills. As before, the sequence of text in the conditioning input to the system may describe the task to be performed, e.g., “What action should the robot take to [perform task]”. Examples of systems for controlling an agent that may be fine tuned as described herein can include PaLM-E (Driess et al. arXiv:2303.03378), RT-1 (Brohan et al. arXiv:2212.06817), and RT-2 (Brohan et al. arXiv:2307.15818).

In some agent control implementations, the environment is a real-world environment and the agent is a mechanical agent interacting with the real-world environment, e.g., a robot or an autonomous or semi-autonomous land, air, or sea vehicle operating in or navigating through the environment, and the actions are actions taken by the mechanical agent in the real-world environment to perform the task. For example, the agent may be a robot or other mechanical agent interacting with the environment to accomplish a specific task, e.g., to locate or manipulate an object of interest in the environment or to move an object of interest to a specified location in the environment or to navigate to a specified destination in the environment. In these implementations, the observations may include, e.g., one or more of: images, object position data, and sensor data to capture observations as the agent interacts with the environment. The actions may define control signals to control the robot or other mechanical agent, e.g., positions, torques, or other control signals for the parts of the mechanical agent, or higher-level control commands.

In some agent control implementations the agent may be a human agent and the environment may be a real-world environment. For example the agent can be a human user of a digital assistant such as a smart speaker, smart display, or some other device that is used to instruct the user to perform actions. The task may be any real-world task that the user wishes to perform. The observations may be obtained from an observation capture subsystem, e.g., a monitoring system such as a video camera or sound capture system, to capture visual observations of the user performing the task. The actions may comprise instructions in the form of, e.g., text, image, video, or audio data such as speech, that guide the user in performing the task.

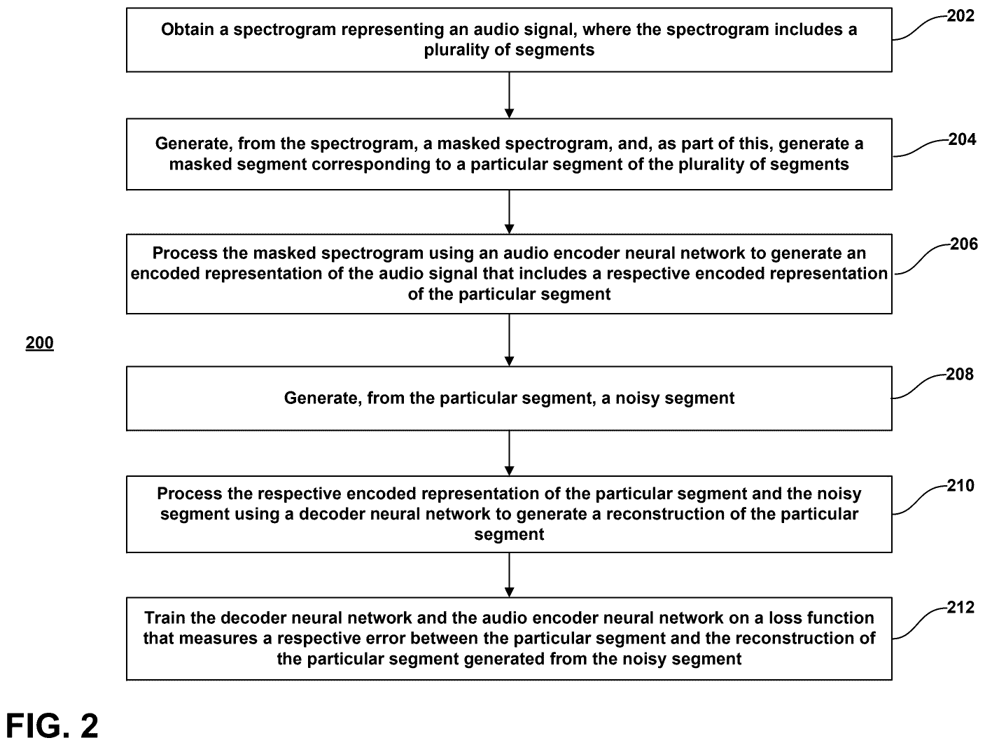

FIG. 2 is a flow diagram of an example process 200 for training an audio encoder neural network. For convenience, the process 200 will be described as being performed by a system of one or more computers located in one or more locations. For example, an image generation system, e.g., the image generation system 100 of FIG. 1, appropriately programmed in accordance with this specification, can perform the process 200.

The system obtains a spectrogram representing an audio signal, where the spectrogram includes a plurality of segments (step 202). The system can obtain the spectrogram from any of a variety of appropriate sources, e.g., a user, another system, system data repository, and so on.

The spectrogram is an ordered collection of values. It can, for example, be displayed as a 2D time—frequency image representation of the audio signal, where each time—frequency pair is associated with a numerical value that represents an intensity value belonging to a unit of measurement (e.g., magnitude of decibels) and can be represented as a color on a color scale. Therefore, the spectrogram can be an ordered collection of numerical values, e.g., a 2D array of numerical values, where columns and rows correspond to time and frequency.

Generally, the plurality of segments of the spectrogram collectively represents the spectrogram. So, any given segment represents a portion of the spectrogram.

For example, the plurality of segments of the spectrogram can be a plurality of time windows of the spectrogram, where each segment corresponds to a different time window and each time window includes the numerical values of intensities for all frequencies for the time window.

The system can create the plurality of segments of the spectrogram using any of a variety of methods. For example, the system can determine a time window size (e.g., 0.4, 4.0, or 40 millisecond time window size) and then subdivide the spectrogram into non-overlapping time windows, where each time window corresponds to a segment as described above.

In some cases, the system obtains the spectrogram by processing the audio signal it represents. For example, for an audio signal represented as an amplitude over time, the system can window the audio signal (i.e., subdivide the audio signal into a sequence of segments representing time windows as described above). Then, the system can Fourier transform each time window to obtain magnitudes for each of a set of frequencies. In some cases, the system also further transforms the resulting magnitudes, e.g., maps the magnitudes onto the Mel scale, applies a log transform, and so on.

The system generates, from the spectrogram, a masked spectrogram. As part of this, the system generates a masked segment corresponding to a particular segment of the plurality of segments (step 204).

A masked segment is a segment whose original values are altered. For example, a masked segment can be a segment whose values have been set to a scalar value (e.g., 0, 1, 0.5), a segment whose values have been set to an average of the respective values of non-masked segments, a segment whose values have been replaced with random values (e.g., random noise drawn from a probability distribution), and so on.

In some cases, as part of generating a masked segment corresponding to a particular segment of the plurality of segments, the system samples each of a plurality of values in the masked segment from a specified distribution.

For example, the system, for each value in the masked segment, can sample the value from a normal distribution with a mean of 0 and a standard deviation of 0.1.

In some cases, as part of generating the masked spectrogram, the system selects one or more segments that include the particular segment to mask. To do so, the system determines with a specified probability at every segment whether to apply a mask to a span (i.e., a fixed number of two or more sequential segments) that begins at the segment, where at least one of the masked spans includes the particular segment. In other words, the system selects one or more segments that include the particular segment to be masked by, for each of a plurality of spans within the spectrogram that each include one or more of the plurality of segments, determining whether to mask out the segments in the span in accordance with a specified probability.

For example, the system can determine at every segment of the spectrogram whether to apply a mask of a fixed length of segments (e.g., 1, 2, or 20 segments) according to a specified probability (e.g., a specified probability of 0.001, 0.01, or 0.1). Then, the system can replace each value included in each segment with a sampled value from a normal distribution (e.g., as described above).

The system processes the masked spectrogram using an audio encoder neural network to generate an encoded representation of the audio signal that includes a respective encoded representation of the particular segment (step 206). The encoded representation of the audio signal generally includes a respective encoded representation of each of multiple segments of the audio signal.

The audio encoder neural network can have any of a variety of neural network architectures. That is, the audio encoder neural network can have any appropriate architecture in any appropriate configuration such that the audio encoder neural network can process a (masked) spectrogram representing an audio signal to generate an encoded representation of the audio signal, including fully connected layers, convolutional layers, recurrent layers, attention-based layers, and so on, as is appropriate.

In some cases, the audio encoder neural network is configured to process an input spectrogram to generate a sequence of embeddings and to process the sequence of embeddings through a plurality of layers to generate an encoded representation of the input spectrogram.

In some implementations, as part of generating the sequence of embeddings, the system processes the input spectrogram through one or more subsampling layers to generate the sequence of embeddings.

For example, the system can process an input (masked) spectrogram using a subsampler that contains one or more convolutional layers to generate a sequence of embeddings, where the size of the sequence of embeddings is smaller than the input (masked) spectrogram. The sequence of embeddings can include features of the spectrogram (e.g., captured through the use of convolutional layers) and can make further processing more computationally efficient (e.g., the sequence of embeddings is smaller in size than the input spectrogram but still contains the primary features of the input spectrogram).

Generally, the plurality of layers of the audio encoder neural network are useful for capturing informative patterns and contextual information of the sequence of embeddings to generate an encoded representation of the input spectrogram and can include any of a variety of layer types.

In some cases, the plurality of layers includes one or more self-attention layers. In other cases, the plurality of layers includes one or more convolutional layers. Yet in other cases, the plurality of layers includes both one or more self-attention layers and one or more convolutional layers.

As a particular example, the audio encoder neural network can include a multi-layer convolutional neural network that first processes the input spectrogram to generate a sequence of embeddings. But also includes multiple conformer blocks (which in turn includes multiple convolutional layers, and multiple self-attention layers, e.g., multi-head attention layers) that then further processes the sequence of embeddings to generate an encoded representation of the input spectrogram.

In some cases, when the system selects one or more segments that includes the particular segment to mask (as described above), the encoded representation of the audio signal includes respective encoded representations of each of the segments.

The system generates, from the particular segment, a noisy segment (step 208).

In some implementations, to generate the noisy segment from the particular segment, the system samples noise from a specified distribution and combines the sampled noise with the particular segment to generate the noisy segment.

For example, the system can sample noise from a noise distribution, e.g., probability distribution, e.g., a Gaussian probability distribution, with the same number of dimensions as the number of values included in the particular segment (i.e., the number dimensions of the particular segment) and elementwise sum the sampled noise with the values of the particular segment to generate the noisy segment.

In some implementations, to generate the noisy segment from the particular segment, the system samples a noise time step for the noisy segment and maps the noise time step to a noise level using a noise schedule. In addition, to combine the sampled noise with the particular segment to generate the noisy segment, the system combines the sampled noise with the particular segment to generate the noisy segment in accordance with the noise level.

For example, the system can use a Markovian process to generate a noisy segment, e.g., the forward process of DDPM. That is, given a particular segment xᵢ (where the subscript i is an index for the particular segment among the segments of the spectorgram), a time step t, and a noise schedule β₁, . . . , β_{T}∈[0,1) across noise time steps, the system can generate the noisy segment

$${x}_{i}^{t} .$$

For example, the equation

$${x}_{i}^{t} = \sqrt{{\overline{a}}_{t}} {x}_{i} + \sqrt{1 - \overline{{a}_{t}}} ϵ$$

represents how the system can generate the noisy segment

$${x}_{i}^{t} .$$

The superscript t represents the noise time step (e.g., a time step sampled from [0,1]); ϵ is noise sampled from a Gaussian distribution, i.e., ϵ˜N(0, 1); the term xᵢ represents the particular segment; and the term a̅ₜ̅ represents the noise level defined according to a noise schedule β₁, . . . , β_{T}∈[0,1), I.e.,

$${\overline{a}}_{t} = {\prod }_{s = 1}^{t} ( 1 - {β}_{s} )$$

for the time step t.

In some implementations, the system further generates, from the particular segment, one or more additional noisy segments.

For example, given a noisy segment defined as \sqrt{a̅ₜ̅}xᵢ+\sqrt{1̅−̅a̅ₜ̅}∈ as described above, the system can combine one or more different e noises with the same particular segment xᵢ to generate one or more respective additional noisy segments. That is, the system can sample one or more values of ϵ for the same noise time step t, for one or more noise time steps t (i.e., noise levels α̅ₜ̅), or both, to generate one or more additional noisy segments for the same particular segment xᵢ.

In some cases, when the system selects one or more segments that includes the particular segment to mask (as described above), the system generates, from each selected segment, a respective noisy segment. For example, for each selected segment with a corresponding index i the system can perform \sqrt{a̅ₜ̅}xᵢ+\sqrt{1-a̅ₜ̅}∈ as described above.

Further for some of these cases, the system generates one or more additional noisy segments for each selected segment. That is, for example, for each selected segment with a corresponding index i the system can perform \sqrt{a̅ₜ̅}xᵢ+\sqrt{1-a̅ₜ̅}∈ for various values of t and ∈ as described above to generate multiple noisy segments for each selected segment.

The system processes the respective encoded representation of the particular segment and the noisy segment using a decoder neural network to generate a reconstruction of the particular segment (step 210).

The decoder neural network can have any of a variety of neural network architectures. That is, the decoder neural network can have any appropriate architecture in any appropriate configuration such that the decoder neural network can process an encoded representation of a particular segment and a noisy segment to generate a reconstruction of the particular segment, including fully connected layers, convolutional layers, recurrent layers, attention-based layers, and so on, as is appropriate.

In some implementations, the decoder neural includes a first subnetwork and second subnetwork. In particular, the first subnetwork is configured to process a first input that includes the noisy segment to generate an updated noisy segment. Additionally, the second subnetwork is configured to process a second input that includes the updated noisy segment and the encoded representation of the particular segment to generate the reconstruction of the particular segment.

Further in some implementations, the first input includes a representation of the noise time step for the noisy segment. For example, the system can process the noise time step t using a time step encoder to generate a representation of the noise time step. As a particular example, the system can use a sinusoidal position encoder to map the noise time step t to a representation of the noise time step (e.g., an embedding vector).

As a particular example, the first subnetwork and the second subnetwork can each be a feed forward neural network (FFN) that includes a FILM layer (i.e., a layer that receives a separate input beyond the primary input of the FFN and applies an affine transformation to an intermediate representation generated by the FNN based on the separate input). This example first subnetwork can process a noisy segment as the primary input and a representation of a noise time step as the separate input for the FILM layer to generate an updated noisy segment. Also, this example second subnetwork can process the encoded representation of the particular segment as the primary input and the updated noisy segment as the separate input for the FILM layer to generate a reconstruction of the particular segment.

As another particular example, the first subnetwork and the second subnetwork can each be a convolutional neural network (CNN) that processes a primary input and a separate input through the use of cross-attention layer(s). This example first subnetwork can process a noisy segment as the primary input and a representation of a noise time step as the separate input through the cross-attention layer(s) to generate an updated noisy segment, i.e., the noisy segment serves as a query sequence and the representation of the noise time step serves as the key-value sequence for the attention mechanism. Also, this example second subnetwork can process the encoded representation of the particular segment as the primary input and the updated noisy segment as the separate input through the cross-attention layer(s) to generate a reconstruction of the particular segment, i.e., the encoded representation of the particular segment serves as a query sequence and the updated noisy segment as serves as the key-value sequence for the attention mechanism.

In some cases, when the system generates one or more additional noisy segments from the particular segment, for each additional noisy segment-particular segment pair, the system generates a reconstruction for the particular segment. That is, for each additional noisy segment, the system processes the respective encoded representation of the particular segment and the additional noisy segment using the decoder neural network to generate a reconstruction of the particular segment.

In some cases, when the system generates one or more additional noisy segments from the one or more selected segments to mask that include the particular segment, for each additional noisy segment—selected segment pair, the system generates a reconstruction for the selected segment. That is, for each additional noisy segment, the system processes the respective encoded representation of the selected segment and the additional noisy segment using the decoder neural network to generate a reconstruction of the selected segment.

The system trains the decoder neural network and the audio encoder neural network on a loss function that measures a respective error between the particular segment and the reconstruction of the particular segment generated from the noisy segment (step 212).

As an example loss function, for a particular segment xᵢ (where subscript i is an index for the segment of a plurality of segments that constitute the spectrogram), a given noise time step t, a scheduled noise level α̅ₜ, and sampled noise ∈, the loss function [symbol] _{iα̅t,∈} can be defined as

$${ℒ}_{i , \overline{{α}_{t}} , ϵ} = {‖ {x}_{i} - D e c ( {h}_{i} , \sqrt{{\overline{α}}_{t}} {x}_{i} + \sqrt{1 - {\overline{α}}_{t}} ϵ ) ‖}^{2} ,$$

where Dec(⋅,⋅) represents the reconstruction of the particular segment that the decoder neural network outputs given the respective encoded representation of the particular segment hᵢ and the noisy segment \sqrt{āₜ}xᵢ+\sqrt{1-āₜ}∈ as described above; the notation ∥⋅∥² is the squared L2 norm and measures a respective error between the particular segment and the reconstruction of the particular segment generated from the noisy segment.

In some implementations, when the system generates one or more additional noisy segments for the particular segment, the loss function also measures, for each additional noisy segment, a respective error between the particular segment and the reconstruction of the particular segment generated from the additional noisy segment.

For example, the above example loss [symbol] _{i,α̅}_{ₜ}_{,∈} can measure the loss for each additional noisy segment as a respective error between the particular segment and the reconstruction of the particular segment generated from the additional noisy segment by substituting the appropriate values of α̅ₜ,∈ pairs for each additional noisy segment.

In some implementations, for each noisy segment in a set that includes the noisy segment and each additional noisy segment, the system determines a mean squared error estimate of the reconstruction generated for the noisy segment.

For example, for a particular segment xᵢ, the mean squared error estimate of the reconstruction generated for the noisy segment in a set that includes the noisy segment and each additional noisy segment can be

$${σ}_{i , \overline{{α}_{t}} , ϵ}^{2}$$

defined as

$${σ}_{i , \overline{{α}_{t}} , ϵ}^{2} = \frac{1}{n} {\sum }_{ϵ} {\sum }_{t} {\vert {x}_{i} - Dec ( {h}_{i} , \sqrt{{\overline{α}}_{t}} {x}_{i} + \sqrt{1 - {\overline{α}}_{t}} ϵ ) \vert}^{2} ,$$

where n is the number of noisy segments in the set and the summation over the indices ∈ and t represent the summation over n noisy segments (i.e., the summation over the noisy segment and each additional noisy segment, where a noisy segment is denoted as \sqrt{a̅ₜ̅}xᵢ+\sqrt{1-a̅ₜ̅}∈ as described above).

For these implementations, the loss function is based on, for each noisy segment in the set, the respective error between the particular segment and the reconstruction of the particular segment generated from the noisy segment and the mean squared error estimate for the noisy segment.

In some of these implementations, the loss function measures, for each noisy segment in the set, a respective log scale loss that has been generated by converting the error between the particular segment and the reconstruction of the particular segment generated from the noisy segment to log scale using the mean squared error estimate for the noisy segment.

For example, for a particular segment xᵢ, the loss can be defined as

$${ℒ}_{𝒾} = {\sum }_{ϵ ∼ 𝒩} {\sum }_{t ∼ [ 0 , 1 ]} ( \frac{{ℒ}_{𝒾 , {α}_{𝓉} , ϵ}}{{σ}_{i , {α}_{t} , ϵ}^{2}} + ln {σ}_{i , {α}_{t} , ϵ}^{2} ) ,$$

where the terms [symbol] _{i,α̅}_{ₜ}_{,∈} and

$${σ}_{i , {α}_{t} , ϵ}^{2}$$

are defined as above, and the summation over the indices ∈ and t represent the summation over n noisy segments of the set. Such a loss function is advantageous when the scale of [symbol] i,α̅ₜ,∈ varies largely for different particular segments and noise time steps because it helps dynamically balance the magnitude of loss associated with different terms.

In some cases, when the system selects one or more segments that includes the particular segment to mask (as described above), the system trains the decoder neural network and the audio encoder neural network on a loss function for each selected segment that measures a respective error between the selected segment and the reconstruction of the selected segment. That is, the system trains the decoder neural network and the audio encoder neural network on a total loss that includes a loss function for each selected segment. The loss function for each selected segment can be any of the above described loss functions.

For example, for selected particular segments with indices i, j, k and respective sets of noisy segments the total loss [symbol] can be [symbol] ᵢ+ [symbol] ⱼ+ [symbol] ₖ where each loss is defined as

$${ℒ}_{𝒾} = {\sum }_{ϵ ∼ 𝒩} {\sum }_{t ∼ [ 0 , 1 ]} ( \frac{{ℒ}_{𝒾 , {α}_{𝓉} , ϵ}}{{σ}_{i , {α}_{t} , ϵ}^{2}} + ln {σ}_{i , {α}_{t} , ϵ}^{2} )$$

as described above.

As part of training, the system iteratively evaluates the loss function and updates the trainable parameters of the decoder neural network and the audio encoder neural network until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

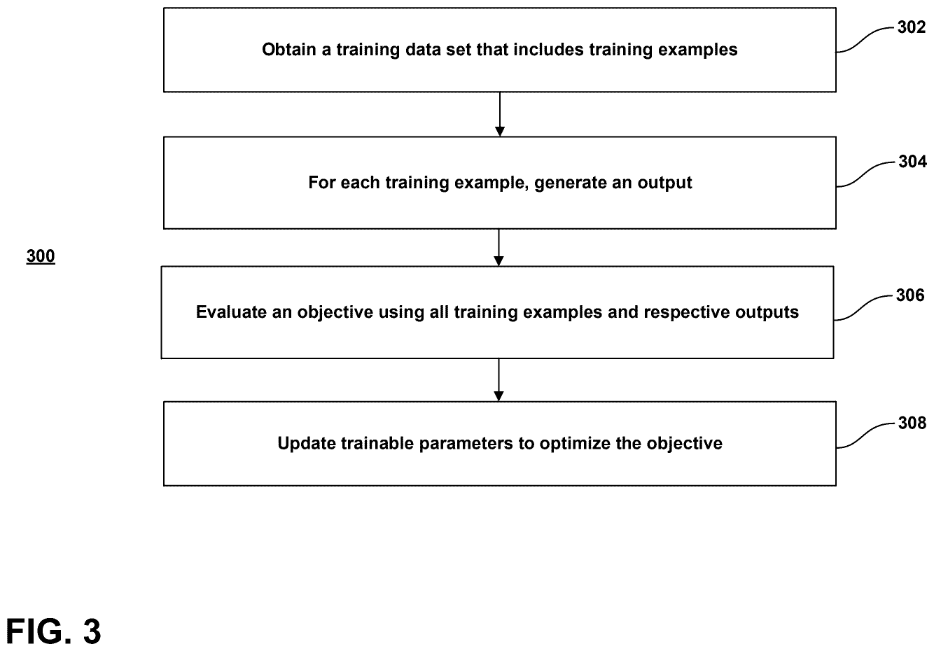

Further details of an example process for updating the trainable parameters of the decoder neural network and audio encoder neural network are described below with reference to FIG. 3.

In some implementations, after the system trains the decoder neural network and audio encoder neural network, the system does not use the decoder neural network. That is, the system, after training, does not use decoder neural network to process noisy segments and respective encoded representations of the segments to generate reconstructions of the segments and the system does not use the decoder neural network as part of any downstream task.

In some implementations, after the system trains the decoder neural network and audio encoder neural network, the system generates encoded representations of new spectrograms using the audio encoder neural network and uses the encoded representations for a downstream task. That is, as described above, the system can process new spectrograms using the audio encoder neural network and use the resulting encoded representations of the new spectrograms to perform the downstream task.

For example, for a downstream task, the system can use the audio encoder neural network to process a new spectrogram to generate an encoded representation of the new spectrogram (i.e., to generate encoded representations of each of multiple segments of the new spectrogram). Then, the system can process the encoded representation of the new spectrogram using a downstream neural network (e.g., using a discriminative model) to generate an output for the downstream task.

As particular examples of the downstream task, the downstream task can be speaker identification (i.e., classifying the speaker within a new spectrogram), audio event detection (i.e., determining if an event has occurred within a new spectrogram), or tone categorization (i.e., classifying the tone of a speaker present in a new spectrogram). As particular examples of the downstream neural network, the downstream neural network can be a discriminative model (e.g., classifier neural networks, logistic regression models, decision tree models, support vector machine models, and so on) that outputs the speaker, event, or tone present in the new spectrogram respectively for the above example downstream tasks.

In some cases, the downstream task is a task performed by a generative model. Some examples of generative models include recurrent neural network transducers (RNN-T), convolutional neural networks, transformer-based neural networks, and so on.

For example, for a downstream task, the system can use the audio encoder neural network to process a new spectrogram to generate an encoded representation of the new spectrogram (i.e., to generate encoded representations of each of multiple segments of the new spectrogram). Then, the system can process the encoded representation of the new spectrogram using a downstream neural network that is a generative model to generate an output for the downstream task.

As a particular example, the downstream task can be speech to speech translation (i.e., converting audio of speech in a first language to audio of speech of a second language), and the downstream neural network can process the encoded representation of the new spectrogram to generate an output sequence of an encoded representation of audio segments (that the system later decodes using an audio decoder to become an audio signal in the second language).

As another particular example, the downstream task can be audio question answering. For this task, the system can receive an input that includes audio and a query about the audio (e.g., represented as audio), as a new spectrogram. Then, the system processes the encoded representation of the new spectrogram using the generative model to generate an output that is response to the query regarding the audio represented as audio.

In some cases, the generative model that performs the downstream task is a multi-modal generative model. That is, the generative model can process input of one or more modalities and generate output of one or more modalities (where the set of all modalities of the input and output includes at least two distinct modalities).

Some examples of multi-modal generative models include neural networks that belong to the Gemini family available from Google and described in arXiv:2312.11805. For example, Gemini 1.0 Ultra with trillions of parameters or Gemini 1.0 Nano-2 or Pro with billions or hundreds of billion parameters.

Some other examples of multi-modal generative models include neural networks that belong to the Gemma family as described in arXiv:2403.08295. For example, Gemma 3n model, Gemma-7B with 7 billion parameters or the Gemma-2B with 2 billion parameters.

When using a multi-modal generative model to perform a downstream task, the system can, for example, use the audio encoder neural network to process a new spectrogram to generate an encoded representation of the new spectrogram (i.e., to generate encoded representations of each of multiple segments of the new spectrogram). Then, the system can process the encoded representation of the new spectrogram (representing audio modality) using a downstream neural network that is a multi-modal generative model to generate an output for the downstream task that includes at least one different modality than audio.

As a particular example, the downstream task can be automatic speech recognition (i.e., converting audio of speech to text), and the downstream neural network can process the encoded representation of the new spectrogram (representing audio modality) to generate an output sequence of text (representing text modality).

As another particular example, the downstream task can be automatic speech translation (i.e., converting audio of speech in a first language to text of speech of a second language), and the downstream neural network can process the encoded representation of the new spectrogram (representing audio modality) to generate an output sequence of text in the second language (representing text modality).

In some implementations, the system processes a new input that includes a new spectrogram and processes an encoded representation of the new input that includes an encoded representation of the new spectrogram using a downstream neural network to perform a downstream task on the new input.

In other words, in some implementations, the system receives a new input, where the new input includes a spectrogram representing a new audio signal. Then, the system processes the new input to generate an encoded representation of the new input. As part of generating the encoded representation of the new input, the system processes the spectrogram using an audio encoder neural network that has been trained by performing any of the above described techniques to generate an encoded representation of the new audio signal. Lastly, the system processes the encoded representation of the new input using a downstream neural network to perform a downstream task on the new input.

To process the encoded representation of the new input, in some cases, the system can use a downstream neural network that is a generative neural network. In some cases, the generative neural network is also a multi-modal generative neural network such as the multi-modal generative neural networks belonging to Gemma family or the Gemini family of neural networks described above.

As an example downstream task for which the system will receive a new input and process an encoded representation of the new input using a downstream multi-modal generative neural network, the system can perform transcript-based audio in-filling. That is, the system can receive a new input that includes a text transcript and audio corresponding to a portion of the text transcript. Then, the system can process the audio as a new spectrogram to generate an encoded representation of the new spectrogram (e.g., using the above described techniques). Additionally, the system can process the text transcript using a text encoder to generate an encoded representation of the text transcript. Afterwards, the system can use a downstream multi-modal neural network (e.g., the Gemini model) to process the encoded representations of the text and audio to generate audio signal corresponding to a different portion of the text transcript that the input audio corresponds to.

As another example downstream task for which the system will receive a new input and process an encoded representation of the new input using a downstream multi-modal generative neural network, the system can perform audio-video question-answering. That is, the system can receive a new input that includes a video, accompanying audio to the video, and a text query regarding the audio-video pair. Then, the system can process the audio as a new spectrogram to generate an encoded representation of the new spectrogram (e.g., using the above described techniques). Additionally, the system can process the text query using a text encoder to generate an encoded representation of the text query, and the system can process the video using a video encoder to generate an encoded representation of the video. Afterwards, the system can use a downstream multi-modal neural network (e.g., the Gemini model) to process the encoded representations of the audio, video, and text query to generate a text response to the text query regarding the audio-video pair.

In some implementations, after the system trains the decoder neural network and the audio encoder neural network, the system fine-tunes the audio encoder neural network on a downstream task. That is, the system obtains a fine-tuning data set that includes new spectrograms (or new inputs that include new spectrograms) associated with the downstream task. Then, the system fine-tunes at least the audio encoder neural network on a loss function that measures the performance of the downstream task.

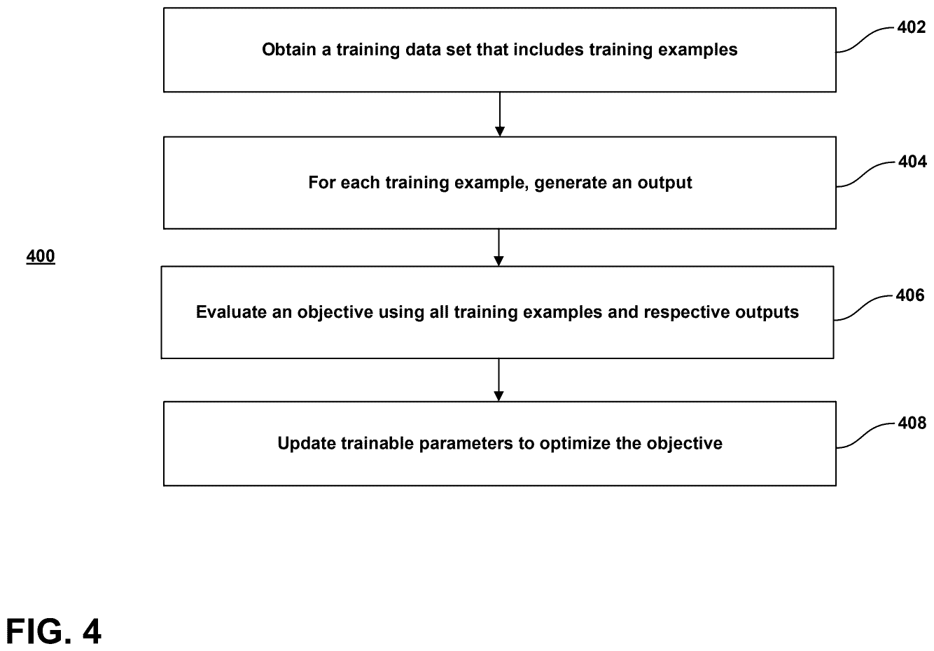

Further details of an example process for fine-tuning an audio encoder neural network on a downstream task are described below with reference to FIG. 4.

FIG. 3 is a flow diagram of an example process 300 for updating trainable parameters during training of the decoder neural network and the audio encoder neural network. For convenience, the process 300 will be described as being performed by a system of one or more computers located in one or more locations. For example, an audio encoder training system, e.g., the audio encoder training system 100 of FIG. 1, appropriately programmed in accordance with this specification, can perform the process 300.

The system repeatedly updates the trainable parameters of the audio encoder neural network and the decoder neural network using a training data set. That is, the system can repeatedly perform the following described example process using training examples to repeatedly update all or a subset of the trainable parameters of the audio encoder neural network and the decoder neural network from scratch, i.e., train from randomly initialized values, or from previously determined values, e.g., pre-trained values.

The system obtains a training data set that includes training examples (step 302), where each training example is a spectrogram (i.e., a spectrogram representing an audio signal that the system will use to train the audio encoder neural network and decoder neural network).

The system, for each training example, generates an output (step 304), where the output is a reconstruction of the particular segment. That is, for each training example, the system processes the spectrogram to generate the reconstruction of the particular segment using the techniques described above, e.g., the techniques described above in reference to FIG. 2.

Additionally, in some cases, when the system selects one or more segments to mask that include the particular segment, the system generates a reconstruction of each of the selected segments of the training example.

Also, when the system generates one or more additional noisy segments from the particular segment, then the system generates a respective reconstruction of the particular segment for each noisy segment—particular segment pair of the training example.

Also, when the system generates one or more additional noisy segments from each of one or more selected segments to mask that includes the particular segment, then the system generates a respective reconstruction of the selected segment for each noisy segment-selected segment pair of the training example.

The system evaluates an objective using all training examples and respective outputs (step 306), where the objective includes a loss function for each training example.

The loss function for each training example measures, as described above, a respective error between the particular segment and the reconstruction of the particular segment generated from the noisy segment of the particular segment.

Generally, the loss function can measure for each reconstruction (e.g., when the outputs include reconstructions of one or more selected segments to mask that include the particular segment), a respective error between the selected segment and the reconstruction of the selected generated from the noisy segment of the selected segment.

When the system generates one or more additional noisy segments from each particular segment, the loss function for each training example can further measure the error between every reconstruction of the particular segment generated from the respective additional noisy segment of the particular segment for every additional noisy segment—particular segment pair of the training example.

When the system generates one or more additional noisy segments for and from each of one or more selected segments to mask that include the particular segment, the loss function for each training example can further measure the error between every reconstruction of the selected segment generated from the respective additional noisy segment of the selected segment for every additional noisy segment—selected segment pair of the training example.

For example, if a training example includes a spectrogram with three particular segments (with indices i, j, k) that are masked, then the total loss for this training example can be, for as example, [symbol] ᵢ+ [symbol] ⱼ+ [symbol] ₖ where each loss is defined as

$${ℒ}_{𝒾} = {\sum }_{ϵ ∼ 𝒩} {\sum }_{t ∼ [ 0 , 1 ]} ( \frac{{ℒ}_{𝒾 , {α}_{𝓉} , ϵ}}{{σ}_{i , {α}_{t} , ϵ}^{2}} + ln {σ}_{i , {α}_{t} , ϵ}^{2} )$$

as described above where the the summation over the indices e and t represent the summation over noisy segments belonging to the particular segment xᵢ.

In some cases, the objective includes one or more regularization terms that penalizes higher values for the trainable parameters to reduce the risk of the trainable parameters overfitting to the training data set. For example, the regularization terms can include the LP regularization term

$$λ {‖ w ‖}_{p}^{p} ,$$

where λ is the regularization parameter, w is the vector of trainable parameters, and p is the norm degree (e.g., p=1 for L1 regularization, p=2 for L2 regularization).

The system updates trainable parameters to optimize the objective (step 308).

The system can update the trainable parameters of the audio encoder neural network and decoder neural network to optimize the objective in any variety of ways, e.g., gradient based method, evolutionary algorithm-based method, Bayesian optimization, etc.

For example, the system can optimize the objective using any of a variety of gradient descent techniques (e.g., batch gradient descent, stochastic gradient descent, or mini-batch gradient descent) that include the use of a backpropagation technique to estimate the gradient of the loss with respect to trainable parameters of the neural network and to update the learnable parameters accordingly.

Generally, the system repeats the above steps until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

FIG. 4 is a flow diagram of an example process 400 for fine-tuning an audio encoder neural network on a downstream task. For convenience, the process 400 will be described as being performed by a system of one or more computers located in one or more locations. For example, an audio encoder training system, e.g., the audio encoder training system 100 of FIG. 1, appropriately programmed in accordance with this specification, can perform the process 400.

The system repeatedly updates the trainable parameters of the audio encoder neural network and (optionally) a downstream neural network using a training data set. That is, the system can repeatedly perform the following described example process using training examples to repeatedly update all or a subset of the trainable parameters of the audio encoder neural network from previously determined values, e.g., pre-trained values, and (optionally) the trainable parameters of the downstream neural network.

The system obtains a training data set that includes training examples (step 402), where each training example includes a downstream task input and a target task output.

As described above, the downstream task can be any of a variety of types of tasks. As some examples, the downstream task can be speaker identification, automatic speech recognition, audio-video question-answering, and so on.

Therefore, the downstream task input of the training example can be a new spectrogram or a new input that includes a new spectrogram, as is appropriate for the downstream task.

For example, if the downstream task is speaker identification or automatic speech recognition, then the downstream task input can be a new spectrogram.

As another example, if the downstream task is audio-video question-answering, then the downstream task input can include a video, a new spectrogram corresponding to the audio of the video, and a text query regarding the audio-video input.

The target task output is the expected output for the downstream task.

For example, if the downstream task is speaker identification, then the target task output can be identification of the speaker present in the corresponding new spectrogram.

As another example, if the downstream task is automatic speech recognition, then the target task output can be text transcript of the speech present in the corresponding new spectrogram.

As another example, if the downstream task is audio-video question-answering, then the target task output can be the text response to the query regarding the audio-video input of the corresponding new input.

The system, for each training example, generates an output (step 404), where the output is a training task output. That is, for each training example, the system generates a training task output using a downstream neural network that is intended to match the target task output. As described above, the downstream neural network can have any type of architecture and can be a generative neural network or multi-modal generative neural network.

As part of generating the training task output, the system processes the new spectrogram representing an audio signal using the audio encoder neural network to generate an encoded representation of the audio signal. When the downstream task input is a new input, the system generates an encoded representation of the new input which includes generating an encoded representation of the new spectrogram included in the new input.

Then, the system processes the encoded representation of the new spectrogram (or the encoded representation of the new input) using the downstream neural network to generate the training task output.

The system evaluates an objective using all training examples and respective outputs (step 406), where the objective includes a loss function for each training example.

The loss function for each training example can be any appropriate loss function that measures the performance of the training task output.

For example, if the downstream task is speaker identification and the training task output is a probability distribution over classes that correspond to potential speakers, then the loss function can be a cross-entropy loss over the classes representing speakers of the training task output and target task output.

As another example, if the downstream task output is automatic speech recognition and the training task output is a probability distribution over a vocabulary for each position of a sequence of text tokens, then the loss function can be cross-entropy loss over text-tokens of the training task output and target task output.

The system updates trainable parameters to optimize the objective (step 408).

The system can update the trainable parameters of the audio encoder neural network and (optionally) the downstream neural network in any variety of ways, e.g., gradient based method, evolutionary algorithm-based method, Bayesian optimization, etc.

For example, the system can optimize the objective using any of a variety of gradient descent techniques (e.g., batch gradient descent, stochastic gradient descent, or mini-batch gradient descent) that include the use of a backpropagation technique to estimate the gradient of the loss with respect to trainable parameters of the neural network and to update the learnable parameters accordingly.

Generally, the system repeats the above steps until one or more criteria are satisfied (e.g., the system performs a pre-determined number of iterations, the updates to the trainable parameters no longer exceed a pre-determined magnitude of change, a metric regarding a validation dataset exceeds a pre-determined value, and so on).

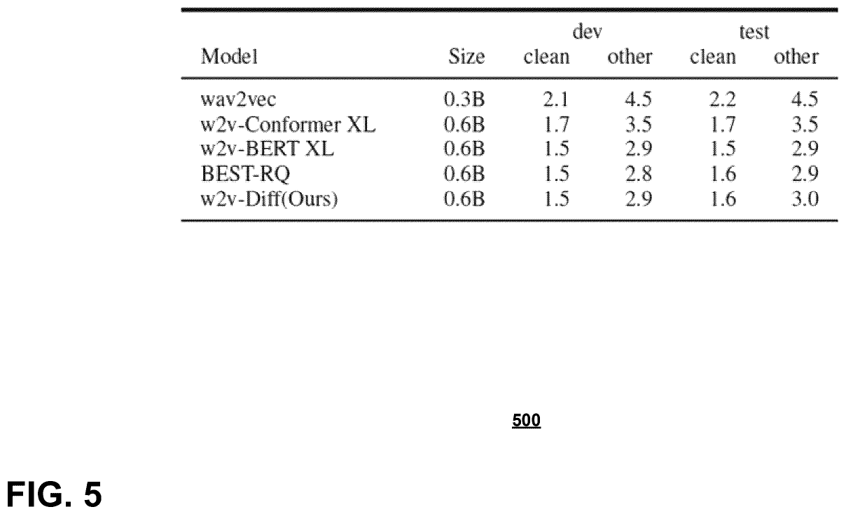

FIG. 5 is an example 500 of the performance of the described techniques.

In particular, example 500 shows a table summarizing the performance of the described techniques (i.e., the row labeled “w2v-Diff(Ours)” along with other techniques on an automatic speech recognition (ASR) task evaluated on the LibriSpeech data set in terms of the word error rate (WER) metric. The WER metric is defined as error rate of transcribed words relative to correctly transcribed words. The LibriSpeech data set is a corpus of approximately 1000 hours of 16 kHz read English speech read from audio books separated into a portion that is “clean” (audio data that has high signal to noise and easy to transcribe) and a portion that is “other” (audio data that has lower signal to noise and is difficult to transcribe). The columns labeled “dev” and “test” refer to the performance on a data set the system uses to fine-tune the audio encoder neural network (i.e., “dev”) and the performance on a test data set not used to fine-tune the audio encoder neural network (i.e. “test”).

The described techniques denoted as w2v-Diff refers to training an audio encoder neural network and a decoder neural network on a loss function that measures a respective error between a particular segment and a reconstruction of the particular segment as described above, e.g., as described with reference to FIG. 2. The other techniques also train their own audio encoder neural network but use contrastive loss functions and quantizations. All techniques first train their audio encoder neural network on the Libri-light data set (a large dataset of 60K hours of unlabeled speech from audiobooks in English) but then fine-tune their audio encoder neural network on the LibriSpeech data set for the ASR task.

Example 500 shows that the described techniques (i.e., w2v-Diff) achieve similar results as other techniques. Yet, w2v-Diff is the first technique to demonstrate that L2 loss of the reconstruction error of a particular segment can achieve similar WER as techniques that include quantization methods and/or contrastive learning. Therefore, for the LibriSpeech data set and ASR task, the encoded representations generated by an audio encoder neural network trained using the described techniques are as informative as other state of the art techniques.

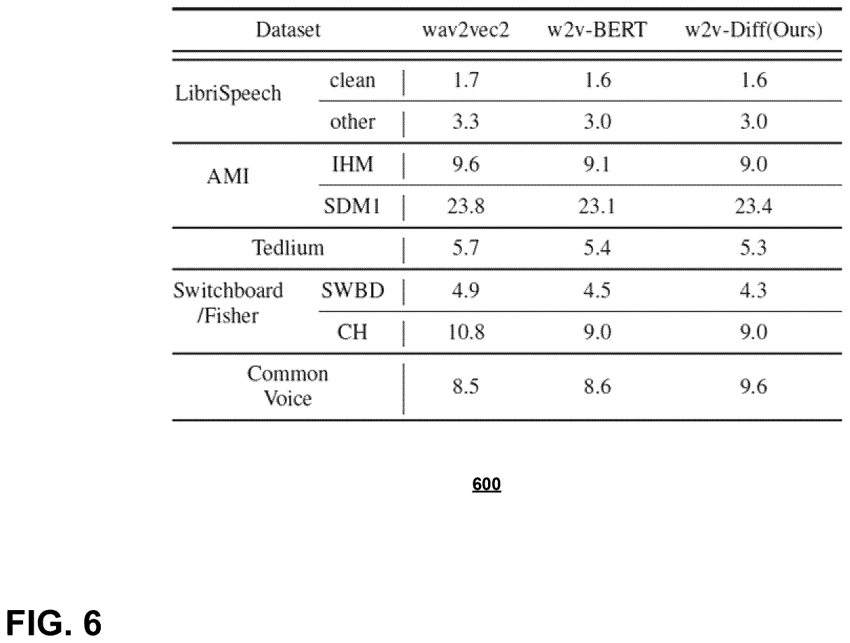

FIG. 6 is an example 600 of the performance of the described techniques.

In particular example 600 shows a table summarizing the performance of the described techniques (i.e., the column labeled “w2v-Diff′ along with other techniques (i.e., wave2vec2 and w2v-BERT) on the ASR task in terms of WER using the SpeechStew data set (which includes data sets belonging to multiple-domains). The SpeechStew data set includes a combination of various publicly available speech recognition data sets: AMI, Broadcast News, Common Voice, LibriSpeech, Switchboard/Fisher, Tedlium, and Wall Street Journal.

For example 600 the described techniques denoted as w2v-Diff refers to training an audio encoder neural network and a decoder neural network on a loss function that measures a respective error between a particular segment and a reconstruction of the particular segment as described above, e.g., as described with reference to FIG. 2. The other techniques (wave2vec2 and w2v-BERT) include the use of quantization methods and/or contrastive learning to train the audio encoder neural network and fine-tunes their audio encoder neural network on the ASR task. All techniques train their audio encoder neural network on the Libri-light data set (a large dataset of 60K hours of unlabeled speech from audiobooks in English) but fine tune on the LibriSpeech data set.

Example 600 shows, the performance of the described techniques (i.e., w2v-Diff) achieves competitive results on the SpeechStew multi-domain data set. It outperforms the other techniques on the challenging data sets AMI IHM, Tedium, Switchboard, and achieves similar results on the other data sets. The described techniques outperform the other techniques on the challenging datasets due to the use of a loss function that measure the error between the particular segment and the reconstruction of the particular segment generated from the noisy segment in a log scale in training the audio encoder neural network. That is, the audio encoder neural network of the described techniques can encode more acoustic information in the encoded representation of the spectrogram than other techniques (that are limited to discrete encoded representations) for challenging spectrograms.

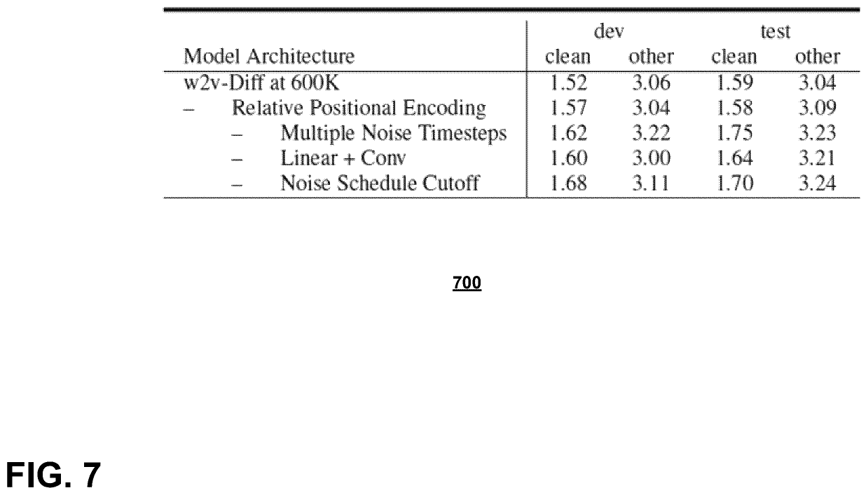

FIG. 7 is an example 700 of the performance of the described techniques.

In particular, example 700 shows a table that summarizes an ablation study of components of the described techniques in terms of the WER metric on the LibriSpeech data set for a ASR task (described above). That is, the rows refer to subsets of aspects of the described techniques. The row labeled “w2v-Diff at 600k” refers is the baseline that does not include any of the below described ablations.

The row labeled “-relative positional encoding” refers to the use of an audio encoder neural network that includes conformer layers without the use of relative positional embedding. Example 700 shows that the use of relative positional embedding slightly improve the performance of the described techniques on the downstream task.

The row labeled “-multiple noise timesteps” refers to not generating a set of noisy segments for a particular segment (but only generating a noisy segment for a particular segment). Example 700 shows that not generating a set of noisy segments for a particular segment and, instead, only generating a single noisy segment for a particular segment decreases the performance of the described techniques on the downstream task.

The row labeled “-linear+Conv” refers to the decoder neural network using a convolutional layer as the receptive field instead of a linear layer. Example 700 shows that use of linear or convolutional layer for the receptive field results in the described techniques performing similarly on the downstream task.

The row labeled “-noise schedule cutoff” refers to the range of noise time steps that noise time steps are sampled from, where the ablation study changes the range from t∈[0.3,1] to t∈[0,1]. Example 700 shows that sampling noise time steps too close to 0 lowers the performance of the described techniques on the downstream task.

Example 700 shows the importance of appropriate choices for various aspects of the described techniques to train an audio encoder neural network to generate encoded representations of segments of spectrograms that are useful for downstream tasks.

In this specification, the term “configured” is used in relation to computing systems and environments, as well as computer program components. A computing system or environment is considered “configured” to perform specific operations or actions when it possesses the necessary software, firmware, hardware, or a combination thereof, enabling it to carry out those operations or actions during operation. For instance, configuring a system might involve installing a software library with specific algorithms, updating firmware with new instructions for handling data, or adding a hardware component for enhanced processing capabilities. Similarly, one or more computer programs are “configured” to perform particular operations or actions when they contain instructions that, upon execution by a computing device or hardware, cause the device to perform those intended operations or actions.

The embodiments and functional operations described in this specification can be implemented in various forms, including digital electronic circuitry, software, firmware, computer hardware (encompassing the disclosed structures and their structural equivalents), or any combination thereof. The subject matter can be realized as one or more computer programs, essentially modules of computer program instructions encoded on a tangible non-transitory storage medium for execution by or to control the operation of a computing device or hardware. The storage medium can be a storage device such as a hard drive or solid-state drive (SSD), a storage medium, a random or serial access memory device, or a combination of these. Additionally or alternatively, the program instructions can be encoded on a transmitted signal, such as a machine-generated electrical, optical, or electromagnetic signal, designed to carry information for transmission to a receiving device or system for execution by a computing device or hardware. Furthermore, implementations may leverage emerging technologies like quantum computing or neuromorphic computing for specific applications, and may be deployed in distributed or cloud-based environments where components reside on different machines or within a cloud infrastructure.

The term “computing device or hardware” refers to the physical components involved in data processing and encompasses all types of devices and machines used for this purpose. Examples include processors or processing units, computers, multiple processors or computers working together, graphics processing units (GPUs), tensor processing units (TPUs), and specialized processing hardware such as field-programmable gate arrays (FPGAs) or application-specific integrated circuits (ASICs). In addition to hardware, a computing device or hardware may also include code that creates an execution environment for computer programs. This code can take the form of processor firmware, a protocol stack, a database management system, an operating system, or a combination of these elements. Embodiments may particularly benefit from utilizing the parallel processing capabilities of GPUs, in a General-Purpose computing on Graphics Processing Units (GPGPU) context, where code specifically designed for GPU execution, often called kernels or shaders, is employed. Similarly, TPUs excel at running optimized tensor operations crucial for many machine learning algorithms. By leveraging these accelerators and their specialized programming models, the system can achieve significant speedups and efficiency gains for tasks involving artificial intelligence and machine learning, particularly in areas such as computer vision, natural language processing, and robotics.

A computer program, also referred to as software, an application, a module, a script, code, or simply a program, can be written in any programming language, including compiled or interpreted languages, and declarative or procedural languages. It can be deployed in various forms, such as a standalone program, a module, a component, a subroutine, or any other unit suitable for use within a computing environment. A program may or may not correspond to a single file in a file system and can be stored in various ways. This includes being embedded within a file containing other programs or data (e.g., scripts within a markup language document), residing in a dedicated file, or distributed across multiple coordinated files (e.g., files storing modules, subprograms, or code segments). A computer program can be executed on a single computer or across multiple computers, whether located at a single site or distributed across multiple sites and interconnected through a data communication network. The specific implementation of the computer programs may involve a combination of traditional programming languages and specialized languages or libraries designed for GPGPU programming or TPU utilization, depending on the chosen hardware platform and desired performance characteristics.

In this specification, the term “engine” broadly refers to a software-based system, subsystem, or process designed to perform one or more specific functions. An engine is typically implemented as one or more software modules or components installed on one or more computers, which can be located at a single site or distributed across multiple locations. In some instances, one or more dedicated computers may be used for a particular engine, while in other cases, multiple engines may operate concurrently on the same one or more computers. Examples of engine functions within the context of AI and machine learning could include data pre-processing and cleaning, feature engineering and extraction, model training and optimization, inference and prediction generation, and post-processing of results. The specific design and implementation of engines will depend on the overall architecture and the distribution of computational tasks across various hardware components, including CPUs, GPUs, TPUs, and other specialized processors.

The processes and logic flows described in this specification can be executed by one or more programmable computers running one or more computer programs to perform functions by operating on input data and generating output. Additionally, graphics processing units (GPUs) and tensor processing units (TPUs) can be utilized to enable concurrent execution of aspects of these processes and logic flows, significantly accelerating performance. This approach offers significant advantages for computationally intensive tasks often found in AI and machine learning applications, such as matrix multiplications, convolutions, and other operations that exhibit a high degree of parallelism. By leveraging the parallel processing capabilities of GPUs and TPUs, significant speedups and efficiency gains compared to relying solely on CPUs can be achieved. Alternatively or in combination with programmable computers and specialized processors, these processes and logic flows can also be implemented using specialized processing hardware, such as field-programmable gate arrays (FPGAs) or application-specific integrated circuits (ASICs), for even greater performance or energy efficiency in specific use cases.

Computers capable of executing a computer program can be based on general-purpose microprocessors, special-purpose microprocessors, or a combination of both. They can also utilize any other type of central processing unit (CPU). Additionally, graphics processing units (GPUs), tensor processing units (TPUs), and other machine learning accelerators can be employed to enhance performance, particularly for tasks involving artificial intelligence and machine learning. These accelerators often work in conjunction with CPUs, handling specialized computations while the CPU manages overall system operations and other tasks. Typically, a CPU receives instructions and data from read-only memory (ROM), random access memory (RAM), or both. The elements of a computer include a CPU for executing instructions and one or more memory devices for storing instructions and data. The specific configuration of processing units and memory will depend on factors like the complexity of the AI model, the volume of data being processed, and the desired performance and latency requirements. Embodiments can be implemented on a wide range of computing platforms, from small embedded devices with limited resources to large-scale data center systems with high-performance computing capabilities. The system may include storage devices like hard drives, SSDs, or flash memory for persistent data storage.

Computer-readable media suitable for storing computer program instructions and data encompass all forms of non-volatile memory, media, and memory devices. Examples include semiconductor memory devices such as read-only memory (ROM), solid-state drives (SSDs), and flash memory devices; hard disk drives (HDDs); optical media; and optical discs such as CDs, DVDs, and Blu-ray discs. The specific type of computer-readable media used will depend on factors such as the size of the data, access speed requirements, cost considerations, and the desired level of portability or permanence.

To facilitate user interaction, embodiments of the subject matter described in this specification can be implemented on a computing device equipped with a display device, such as a liquid crystal display (LCD) or an organic light-emitting diode (OLED) display, for presenting information to the user. Input can be provided by the user through various means, including a keyboard), touchscreens, voice commands, gesture recognition, or other input modalities depending on the specific device and application. Additional input methods can include acoustic, speech, or tactile input, while feedback to the user can take the form of visual, auditory, or tactile feedback. Furthermore, computers can interact with users by exchanging documents with a user's device or application. This can involve sending web content or data in response to requests or sending and receiving text messages or other forms of messages through mobile devices or messaging platforms. The selection of input and output modalities will depend on the specific application and the desired form of user interaction.

Machine learning models can be implemented and deployed using machine learning frameworks, such as TensorFlow or JAX. These frameworks offer comprehensive tools and libraries that facilitate the development, training, and deployment of machine learning models.

Embodiments of the subject matter described in this specification can be implemented within a computing system comprising one or more components, depending on the specific application and requirements. These may include a back-end component, such as a back-end server or cloud-based infrastructure; an optional middleware component, such as a middleware server or application programming interface (API), to facilitate communication and data exchange; and a front-end component, such as a client device with a user interface, a web browser, or an app, through which a user can interact with the implemented subject matter. For instance, the described functionality could be implemented solely on a client device (e.g., for on-device machine learning) or deployed as a combination of front-end and back-end components for more complex applications. These components, when present, can be interconnected using any form or medium of digital data communication, such as a communication network like a local area network (LAN) or a wide area network (WAN) including the Internet. The specific system architecture and choice of components will depend on factors such as the scale of the application, the need for real-time processing, data security requirements, and the desired user experience.

The computing system can include clients and servers that may be geographically separated and interact through a communication network. The specific type of network, such as a local area network (LAN), a wide area network (WAN), or the Internet, will depend on the reach and scale of the application. The client-server relationship is established through computer programs running on the respective computers and designed to communicate with each other using appropriate protocols. These protocols may include HTTP, TCP/IP, or other specialized protocols depending on the nature of the data being exchanged and the security requirements of the system. In certain embodiments, a server transmits data or instructions to a user's device, such as a computer, smartphone, or tablet, acting as a client. The client device can then process the received information, display results to the user, and potentially send data or feedback back to the server for further processing or storage. This allows for dynamic interactions between the user and the system, enabling a wide range of applications and functionalities.

While this specification contains many specific implementation details, these should not be construed as limitations on the scope of any invention or on the scope of what may be claimed, but rather as descriptions of features that may be specific to particular embodiments of particular inventions. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially be claimed as such, one or more features from a claimed combination can in some cases be excised from the combination, and the claimed combination may be directed to a subcombination or variation of a subcombination.

Similarly, while operations are depicted in the drawings and recited in the claims in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system modules and components in the embodiments described above should not be understood as requiring such separation in all embodiments, and it should be understood that the described program components and systems can generally be integrated together in a single software product or packaged into multiple software products.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In some cases, multitasking and parallel processing may be advantageous.

What is claimed is:

1. A method performed by one or more computers, the method comprising:
obtaining a spectrogram representing an audio signal, the spectrogram comprising a plurality of segments;
generating, from the spectrogram, a masked spectrogram, comprising generating a masked segment corresponding to a particular segment of the plurality of segments;
processing the masked spectrogram using an audio encoder neural network to generate an encoded representation of the audio signal that comprises a respective encoded representation of the particular segment;
generating, from the particular segment, a noisy segment; and
processing the respective encoded representation of the particular segment and the noisy segment using a decoder neural network to generate a reconstruction of the particular segment; and
training the decoder neural network and the audio encoder neural network on a loss function that measures a respective error between the particular segment and the reconstruction of the particular segment generated from the noisy segment.

2. The method of claim 1, wherein generating a masked segment corresponding to the particular segment comprises:
sampling each of a plurality of values in the masked segment from a specified distribution.

3. The method of claim 1, wherein generating, from the spectrogram, a masked segment comprises:
selecting one or more segments that comprise the particular segment by, for each of a plurality of spans within the spectrogram that each include one or more of the plurality of segments, determining whether to mask out the segments in the span in accordance with a specified probability.

4. The method of claim 1, wherein generating, from the particular segment, a noisy segment comprises:
sampling noise from a specified distribution; and
combining the sampled noise with the particular segment to generate the noisy segment.

5. The method of claim 4, wherein generating, from the particular segment, a noisy segment further comprises:
sampling a noise time step for the noisy segment; and
mapping the noise time step to a noise level using a noise schedule, wherein combining the sampled noise with the particular segment to generate the noisy segment comprises combining the sampled noise with the particular segment to generate the noisy segment in accordance with the noise level.

6. The method of claim 1, further comprising:
generating, from the particular segment, one or more additional noisy segments; and
for each additional noisy segment, processing the respective encoded representation of the particular segment and the additional noisy segment using the decoder neural network to generate a reconstruction of the particular segment; and
wherein the loss function also measures, for each additional noisy segment, a respective error between the particular segment and the reconstruction of the particular segment generated from the additional noisy segment.

7. The method of claim 6, further comprising, for each noisy segment in a set that includes the noisy segment and each additional noisy segment:
determining a mean squared error estimate of the reconstruction generated for the noisy segment; wherein:
the loss function is based on, for each noisy segment in the set, the respective error between the particular segment and the reconstruction of the particular segment generated from the noisy segment and the mean squared error estimate for the noisy segment.

8. The method of claim 7, wherein the loss function measures, for each noisy segment in the set, a respective log scale loss that has been generated by converting the error between the particular segment and the reconstruction of the particular segment generated from the noisy segment to log scale using the mean squared error estimate for the noisy segment.

9. The method of claim 1, wherein the decoder neural network comprises:
a first subnetwork configured to process a first input comprising the noisy segment to generate an updated noisy segment; and
a second subnetwork configured to process a second input comprising the updated noisy segment and the encoded representation of the particular segment to generate the reconstruction of the particular segment.

10. The method of claim 9, wherein generating, from the particular segment, a noisy segment comprises:
sampling noise from a specified distribution; and
combining the sampled noise with the particular segment to generate the noisy segment;
wherein generating, from the particular segment, a noisy segment further comprises:
sampling a noise time step for the noisy segment; and
mapping the noise time step to a noise level using a noise schedule, wherein combining the sampled noise with the particular segment to generate the noisy segment comprises combining the sampled noise with the particular segment to generate the noisy segment in accordance with the noise level; and
wherein the first input comprises a representation of the noise time step.

11. The method of claim 1, further comprising:
after the training, generating encoded representations of new spectrograms using the audio encoder neural network and using the encoded representations for a downstream task.

12. The method of claim 11, wherein the downstream task is a task performed by a generative model.

13. The method of claim 12, wherein the generative model is a multi-modal generative model.

14. A method performed by one or more computers, the method comprising:
receiving a new input, the new input comprising a spectrogram representing a new audio signal;
processing the new input to generate an encoded representation of the new input, comprising processing the spectrogram using an audio encoder neural network that has been trained by performing the respective operations of the method of claim 1 to generate an encoded representation of the new audio signal; and
processing the encoded representation of the new input using a downstream neural network to perform a downstream task on the new input.

15. The method of claim 14, wherein the downstream neural network is a generative neural network.

16. The method of claim 15, wherein the downstream neural network is a multi-modal generative neural network.

17. A method performed by one or more computers, the method comprising:
receiving a new input, the new input comprising a spectrogram representing a new audio signal;
processing the new input to generate an encoded representation of the new input, comprising processing the spectrogram using an audio encoder neural network to generate an encoded representation of the new audio signal, wherein the audio encoder neural network has been trained jointly with a decoder neural network, wherein the training comprises denoising a noisy segment using the decoder, wherein the denoising is conditioned on an encoded representation of a corresponding masked segment, the encoded representation being generated by the audio encoder neural network; and
processing the encoded representation of the new input using a downstream neural network to perform a downstream task on the new input.

18. The method of claim 17, wherein the downstream neural network is a generative neural network.

19. The method of claim 17, wherein the downstream neural network is a multi-modal generative neural network.

20. The method of claim 1, wherein the audio encoder neural network is configured to process an input spectrogram to generate a sequence of embeddings and to process the sequence of embeddings through a plurality of layers to generate an encoded representation of the input spectrogram.

21. The method of claim 20, wherein the plurality of layers comprise one or more self-attention layers.

22. The method of claim 20, wherein the plurality of layers comprise one or more convolutional layers.

23. The method of claim 1, wherein processing the input spectrogram to generate a sequence of embeddings comprises processing the input spectrogram through one or more subsampling layers to generate the sequence of embeddings.

24. A system comprising one or more computers and one or more storage devices storing instructions that when executed by the one or more computers cause the one more computers to perform operations, the operations comprising:
obtaining a spectrogram representing an audio signal, the spectrogram comprising a plurality of segments;
generating, from the spectrogram, a masked spectrogram, comprising generating a masked segment corresponding to a particular segment of the plurality of segments;
processing the masked spectrogram using an audio encoder neural network to generate an encoded representation of the audio signal that comprises a respective encoded representation of the particular segment;
generating, from the particular segment, a noisy segment; and
processing the respective encoded representation of the particular segment and the noisy segment using a decoder neural network to generate a reconstruction of the particular segment; and
training the decoder neural network and the audio encoder neural network on a loss function that measures a respective error between the particular segment and the reconstruction of the particular segment generated from the noisy segment.
